(19) United States
(12) Patent Application Publication
(10) Pub. No.: US 2025/0293737 A1
(43) Pub. Date: Sep. 18, 2025

(54) RECONFIGURABLE SPACE TIME AND SPACE FREQUENCY ADAPTIVE PROCESSING

(71) Applicant: BAE SYSTEMS Information and Electronic Systems Integration Inc., Nashua, NH (US)

(72) Inventor: Michael H. STOCKMASTER, Cedar Rapids, IA (US)

(73) Assignee: BAE SYSTEMS Information and Electronic Systems Integration Inc., Nashua, NH (US)

(21) Appl. No.: 18/608,201

(22) Filed: Mar. 18, 2024

(51) Int. Cl. H04B 7/06; H04L 5/00

(52) U.S. Cl. CPC H04B 7/0617; H04L 5/0005

(57) ABSTRACT

Techniques for adaptive signal processing. A methodology implementing the techniques according to an example includes converting T blocks of buffered time domain signals received from C channels of an antenna array to T blocks of frequency domain signals, wherein each frequency domain signal comprises N frequency domain bins. The method also includes calculating N covariance matrices based on the T blocks of frequency domain signals for each of the N bins and generating M combined covariance matrices by combining groups of covariance matrices from the N covariance matrices corresponding to a number of adjacent frequency domain bins. The method further includes generating M reduced covariance matrices by extracting a portion from each of the M combined covariance matrices, the portion corresponding to Z of the T blocks. The method further includes calculating weights based on the M reduced covariance matrices to control the antenna array.

### FIELD OF DISCLOSURE

The present disclosure relates to signal processing, and more particularly to a signal processing system that is adaptive in space time and space frequency.

### BACKGROUND

Many signal processing systems, including systems used for communication, surveillance, and navigation, may employ antenna arrays to receive those signals. By weighting the signals received through the antennas, various functions can be performed including beamforming, null forming, and jamming mitigation.

### BRIEF DESCRIPTION OF THE DRAWINGS

FIG. 1 illustrates a system configured to implement reconfigurable space time and space frequency adaptive processing (STAP/SFAP), in accordance with certain embodiments of the present disclosure.

FIG. 2 is a block diagram of the STAP/SFAP processor of FIG. 1, configured in accordance with certain embodiments of the present disclosure.

FIG. 3 illustrates examples of scalable SFAP processing, in accordance with certain embodiments of the present disclosure.

FIG. 4 illustrates one example of scalable STAP/SFAP processing, in accordance with certain embodiments of the present disclosure.

FIG. 5 illustrates another example of scalable STAP/SFAP processing, in accordance with certain embodiments of the present disclosure.

FIG. 6 is a flowchart illustrating a methodology for reconfigurable STAP/SFAP, in accordance with an embodiment of the present disclosure.

FIG. 7 is a block diagram of a processing platform configured to provide reconfigurable STAP/SFAP, in accordance with an embodiment of the present disclosure.

Although the following Detailed Description will proceed with reference being made to illustrative embodiments, many alternatives, modifications, and variations thereof will be apparent in light of this disclosure.

### DETAILED DESCRIPTION

Techniques are provided herein for dynamically reconfigurable space time and space frequency adaptive processing (STAP/SFAP). In an example, the techniques are implemented in a STAP/SFAP processor that is configured to generate weights for control of an antenna array. As noted above, communication systems, surveillance systems, navigation systems, and the like, may employ antenna arrays to receive signals. By applying weights to the signals received via each antenna of the array, also referred to as a channel, various functions can be performed including beamforming, null forming, and interference mitigation (e.g., anti-jamming). Existing receivers typically implement a single algorithm such as space time adaptive processing (STAP), space frequency adaptive processing (SFAP), or spatial-only processing to generate antenna weights. The processors in such receivers are designed with fixed firmware and/or software that is configured to address a particular performance requirement and thus are difficult to readily modify. By providing the capability to adaptively reconfigure the receiver in real-time to implement different algorithms at different levels of spatial and temporal resolution, for example in response to detection of changing environments, the disclosed techniques enable a given receiver to dynamically leverage the advantages provided by each algorithm and each level of resolution for a particular situation.

To this end, and in accordance with an embodiment of the present disclosure, a system architecture is disclosed to perform any desired combination of STAP and SFAP at reconfigurable levels of temporal resolution for STAP, and reconfigurable levels of frequency (or spatial) resolution for SFAP, as will be described in greater detail below. For instance, the processing can be adapted to be less aggressive (e.g., lower resolution) when the threat environment can be mitigated with less computationally demanding processing.

In accordance with an embodiment, a methodology implementing the techniques for STAP/SFAP weight generation includes buffering an integer number of blocks (T) of time domain signals received from each of an integer number of channels (C) of an antenna array. The method further includes converting the T blocks of time domain signals to T blocks of frequency domain signals for each of the C channels, wherein each of the frequency domain signals comprise an integer number of frequency domain bins (N). The method further includes calculating N covariance matrices based on the T blocks of the C frequency domain signals for each of the N frequency domain bins. Each of the covariance matrices are of size C times T by C times T, hereinafter referred to as CTxCT. The method further includes generating an integer number (M) of combined covariance matrices by combining groups of covariance matrices from the N covariance matrices. Each group corresponds to a respective grouping of adjacent frequency domain bins from the N frequency domain bins. The method further includes generating M reduced covariance matrices by extracting a portion from each of the M combined covariance matrices, the portion corresponding to an integer number (Z) of the T blocks, wherein Z is less than or equal to T. In some embodiments, the values of M and Z may be varied over to time to provide dynamic reconfigurability of the system, for example based on a level of interference detected in signals received from the antenna array. The method further includes calculating weights based on the M reduced covariance matrices to control the antenna array.

It will be appreciated that the techniques described herein for dynamic reconfiguration of the signal processing used to generate antenna weights may provide improved receiver performance, including improved anti-jamming capabilities, compared to other systems that are custom designed to implement a particular signal processing algorithm. Numerous embodiments and applications will be apparent in light of this disclosure.

### System Architecture

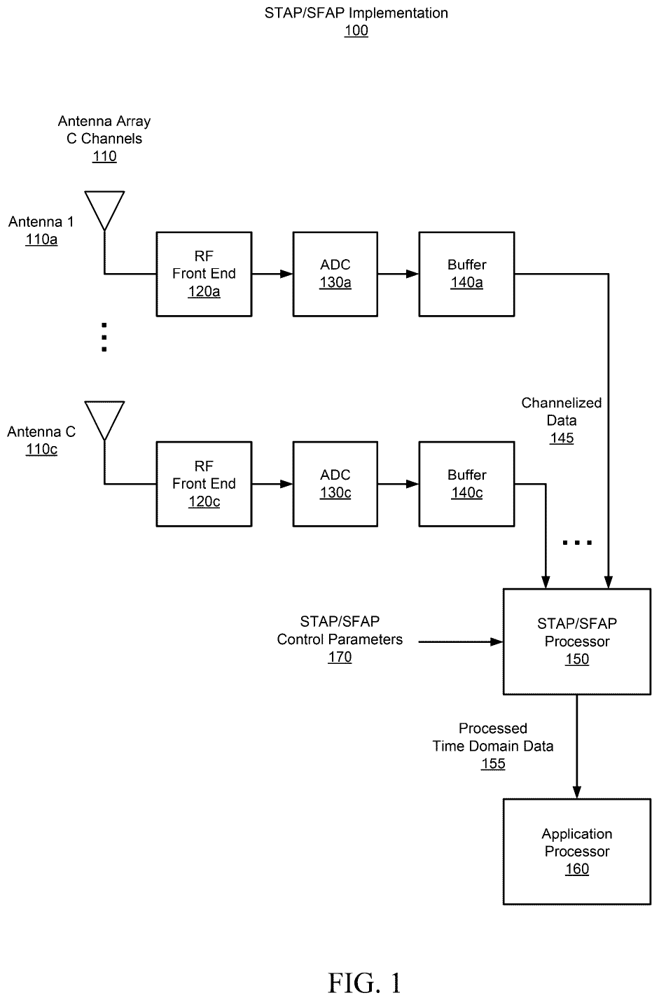

FIG. 1 illustrates a system 100 configured to implement reconfigurable space time and space frequency adaptive processing (STAP/SFAP), in accordance with certain embodiments of the present disclosure. The system 100 is shown to include an antenna array 110, radio frequency (RF) front ends 120, analog to digital converters (ADCs) 130, buffers 140, a STAP/SFAP processor 150, and an application processor 160.

The antenna array 110 comprises C antenna elements 110a, . . . 110c, and is configured to receive RF signals from any number of sources which may include, for example, Global Navigation Satellite System (GNSS) satellites, communications sources, signal jammers, etc. The antenna array 110 provides the received RF signals to RF front ends 120a, . . . 120c that, in some embodiments, are configured to convert the received RF signals on each channel down to an intermediate frequency (IF) signal or a baseband signal and perform any suitable filtering and amplification. ADCs 130a, . . . 130c are configured to convert the analog signals provided by the RF front ends 120 into digital time domain signals, also referred to as channelized data 145, comprising complex data samples (e.g., in-phase and quadrature data samples). The buffers 140a, . . . 140c, are configured to buffer a number of blocks, T blocks, of the time domain signals 145 received from each of the C channels of the antenna array. Each of the T blocks may include a number of samples, N samples.

Operation of the STAP/SFAP processor 150 will be described in greater detail below, but at a high level, the STAP/SFAP processor 150 is configured to perform any desired combination of STAP and SFAP at reconfigurable levels of temporal resolution for STAP, and reconfigurable levels of frequency resolution for SFAP. The STAP/SFAP control parameters 170 may be provided by an external application to control the reconfigurability of the STAP/SFAP processor 150, for example based on monitoring of environmental conditions such as detected levels of interference. The STAP/SFAP processing is performed on the channelized data 145 received through the antenna array 110 to generate processed time domain data 155.

The application processor 160 is configured to receive the processed time domain data 155 and perform any further application specific processing. For example, the application processor may be a GNSS receiver configured to calculate navigation information from the processed time domain data 155, wherein the STAP/SFAP processing mitigated the effects of a hostile jammer attempting to deny access to the GNSS signal. In other examples, the application processor 160 may be a communications receiver configured to decode messages in the processed time domain data 155, wherein the STAP/SFAP processing steered a beam in the direction of the transmitter to improve the signal to interference ratio of the message signal.

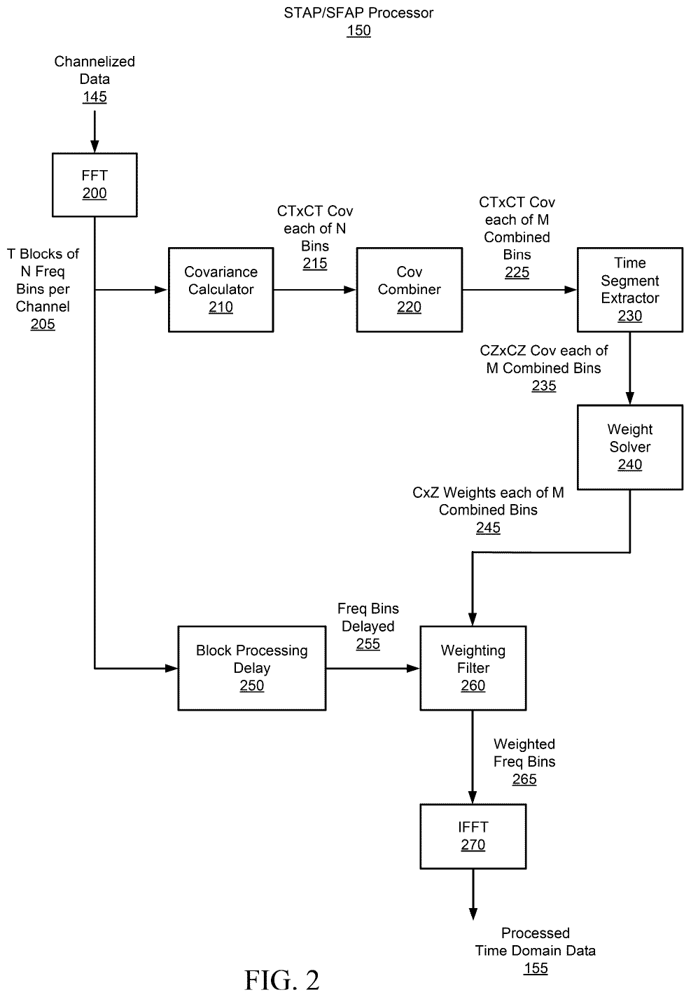

FIG. 2 is a block diagram of the STAP/SFAP processor 150 of FIG. 1, configured in accordance with certain embodiments of the present disclosure. The STAP/SFAP processor 150 is shown to include a fast Fourier transform (FFT) circuit 200, a covariance calculator 210, a covariance combiner 220, a time segment extractor 230, a weight solver 240, a block processing delay 250, a weighting filter 260, and an inverse FFT circuit 270.

The fast Fourier transform (FFT) circuit 200 is configured to convert the T blocks of time domain signals, from the provide channelized data 145, to T blocks of frequency domain signals 205 for each of the C channels. Each of the C frequency domain signal 205 comprises N frequency domain bins. In some embodiments, a discrete Fourier transform may be used rather than an FFT. In some other embodiments, other types of transforms may be used that convert from the time domain to other domains, such as for example a wavelet transform or any other desired transform.

The covariance calculator 210 is configured to calculate N covariance matrices 215 based on the T blocks of the C frequency domain signals 205 for each of the N frequency domain bins. Each of the N covariance matrices 215 is of size CTxCT. The covariance matrices capture spatial information about the environment in each frequency bin.

The covariance combiner 220 is configured to generate M combined covariance matrices 225 by combining (e.g., summing) groups of covariance matrices from the N covariance matrices 215. Each group corresponds to a respective grouping of adjacent frequency domain bins from the N frequency domain bins. Grouping of adjacent bins may take advantage of the fact that data in adjacent bins are more closely related and/or that adjacent bins are correlated to some extent. In some embodiments, however, other types of grouping can be performed as well, such as first M even-numbered bins, first M odd-number bin, next M even-numbered bins, and so on, for example.

The time segment extractor 230 is configured to generate M reduced covariance matrices 235 by extracting a portion from each of the M combined covariance matrices 225, in particular, CZxCZ matrices are extracted from the larger CTxCT matrices. The portions correspond to Z of the T blocks, wherein Z is less than or equal to T.

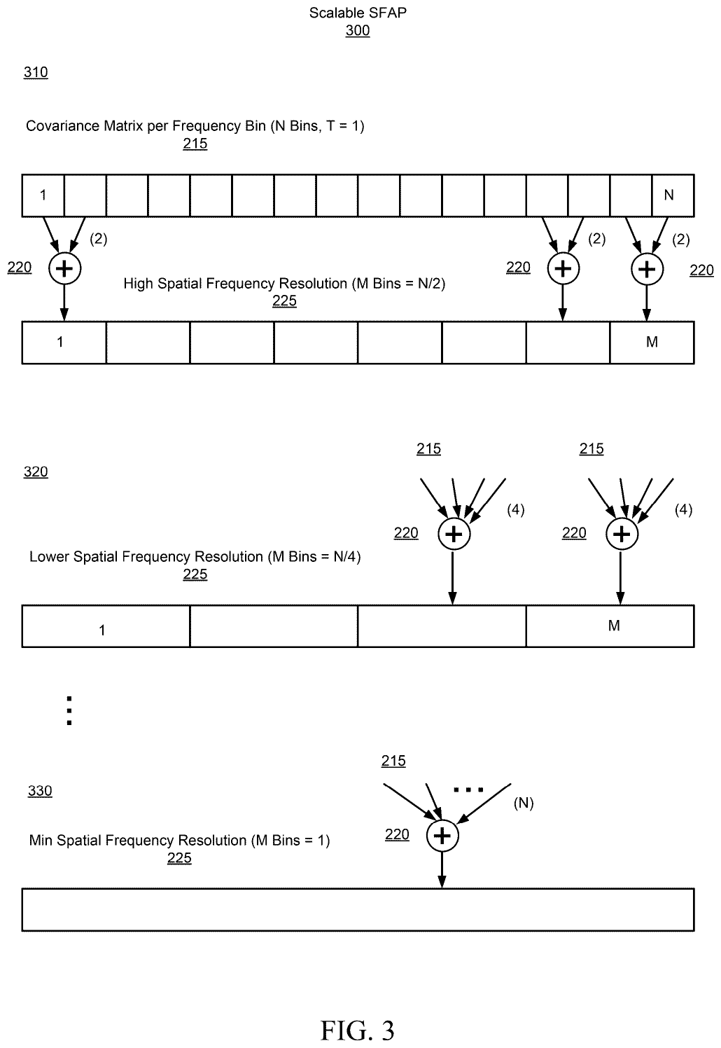

The effect of the selection of the factors M and Z on the dynamic reconfigurability of the system will be described in greater detail below in connection with FIGS. 3-5. The factors M and Z may be set by the STAP/SFAP control parameters 170.

The weight solver 240 is configured to calculate weights 245, to control the antenna array, based on the M reduced covariance matrices 235. In some embodiments, the weights are calculated using a constraint minimization process although other suitable techniques may be used.

For example, in one embodiment the constraint minimization process may be expressed as:

W=Rₓₓ⁻¹*v

Where W represents the weights 245, Rₓₓ represents the covariance matrices 235, and v is an application specific constraint vector which may be formulated to provide one or more of interference mitigation, maximizing signal to interference and noise ratio (SINR), beamforming, and nullforming, although other constraints and applications are possible.

The block processing delay 250 is configured to generate delayed frequency domain signals 255 from the T blocks of frequency domain signals 205 for each of the C channels. The delay is introduced to compensate for the delay required for the calculation of the covariance matrices and weight generation described above so that the generated weights 245 can be applied to the data from which the weights were generated.

The weighting filter 260 is configured to apply the weights 245 to the delayed frequency domain signals 255 to generate weighted frequency bins 265. In some embodiments, the weighting filter 260 is implemented as a finite impulse response (FIR) filter.

The inverse FFT circuit 270 is configured to convert the weighted frequency domain bins 265 back to the time domain to generate the adaptively processed time domain signals 155.

FIG. 3 illustrates examples of scalable SFAP processing 300, in accordance with certain embodiments of the present disclosure. In these examples for SFAP without STAP, only one block is used at a time (e.g., T is set to 1).

In the first example 310, the N covariance matrices 215 are shown in a row format from left to right. Each covariance matrix is associated with one frequency bin, ranging from 1 to N. Each covariance matrix is of size C×C since T is set to 1. The covariance combiner 220 is configured (or reconfigured) to combine pairs of adjacent bins to generate combined covariance matrices 225 at a reduced, but still relatively high, spatial frequency resolution at M bins, where M=N/2.

In the second example, the covariance combiner 220 is configured (or reconfigured) to combine groups of four adjacent bins to generate combined covariance matrices 225 at a lower spatial frequency resolution at M bins, where M=N/4.

In the third example, the covariance combiner 220 is configured (or reconfigured) to combine all of the N bins to generate combined covariance matrices 225 at the lowest spatial frequency resolution of one bin.

For each of these examples, the weight solver 240 will generate C complex weights 245, (one weight for the C antennas) for each of the M bins. The weighting filter 260 will apply the weights to the delayed frequency bins 255.

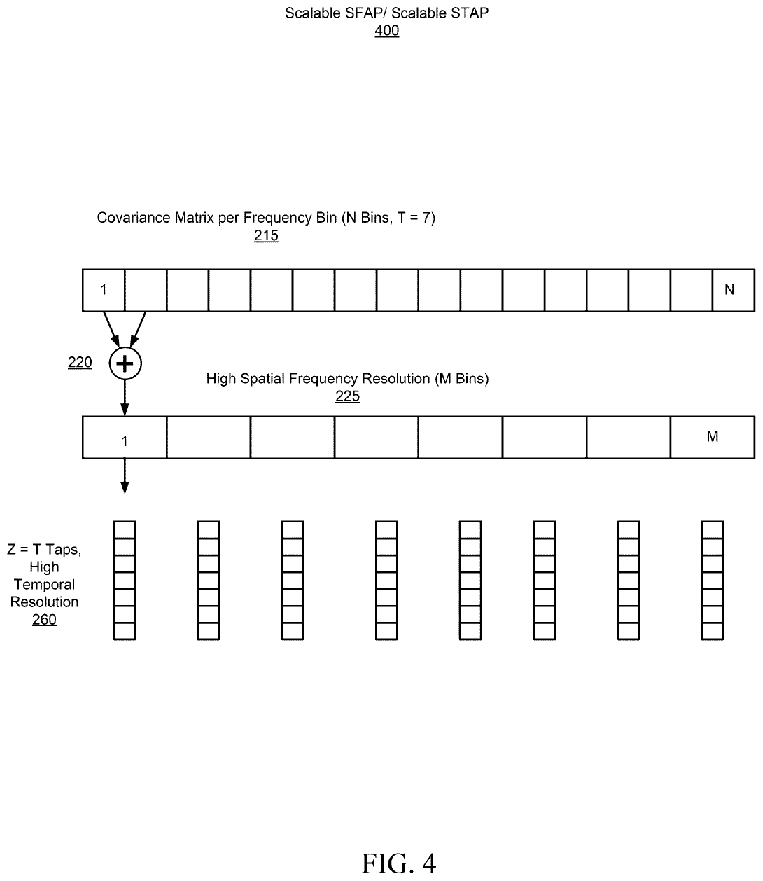

FIG. 4 illustrates one example of scalable STAP/SFAP processing 400, in accordance with certain embodiments of the present disclosure. In this example, the system is configured (or reconfigured) to use T blocks (e.g., T is set to 7) for a combination of STAP and SFAP, such that STAP is implemented in each of the M effective frequency bins. The N covariance matrices 215 are again shown in a row format from left to right with each covariance matrix associated with one frequency bin, ranging from 1 to N. Now, however, each covariance matrix is of size CTxCT since C is greater than 1. The covariance combiner 220 is configured to combine pairs of adjacent bins to generate combined covariance matrices 225 at the spatial frequency resolution of M bins, where M=N/2. The value of T=7 may, in some embodiments, represent a relatively high temporal resolution. For example, the system may be designed to handle a maximum value of T=7 which represents the high end of STAP reconfigurability for the system. Since all 7 blocks will be used, Z is set to 7 and the time segment extractor 230 does not perform any extraction. The weight solver 240 will generate CxT weights 245 for each of the M bins and the weighting filter 260 will use T=7 taps of the FIR filter to apply the weights.

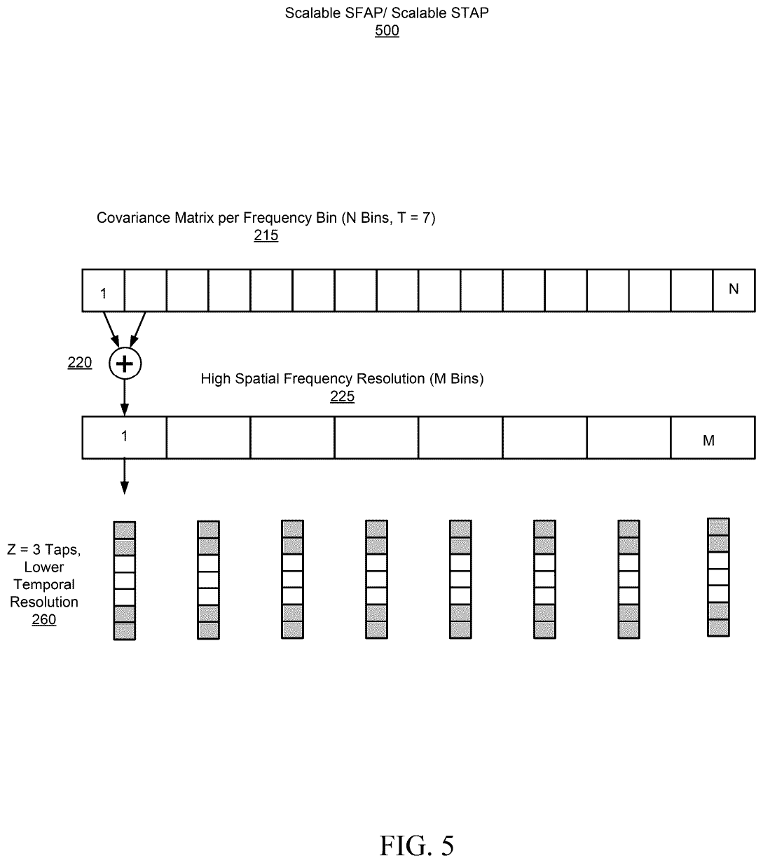

FIG. 5 illustrates another example of scalable STAP/SFAP processing 500, in accordance with certain embodiments of the present disclosure. In this example, the system is configured (or reconfigured) to use less than T blocks (e.g., T is set to 3) for a different combination of STAP and SFAP. The N covariance matrices 215 are again shown in a row format from left to right with each covariance matrix associated with one frequency bin, ranging from 1 to N. where, each covariance matrix is of size CTxCT. The covariance combiner 220 is again configured to combine pairs of adjacent bins to generate combined covariance matrices 225 at the spatial frequency resolution of M bins, where M=N/2. In this example, however, Z is set to 3 which represent a lower temporal resolution than in the previous example. The time segment extractor 230 extracts CZxCZ matrices 235 from the larger CTxCT matrices 225 for each of the M combined bins. The weight solver 240 will generate CxZ weights for each of the M bins and the weighting filter 260 will use Z=3 taps of the FIR filter to apply the weights. In some embodiments, the four shaded taps may be set to zero.

It will be appreciated that many other configurations can be achieved by varying the factors M and Z, for instance through the STAP/SFAP control parameters 170. Some additional examples include the following:

For the case M=N and Z=1, the system would implement standard SFAP.

For the case M<N and Z=1, the system implements scalable SFAP.

For the case M=1 and Z=T, the system implements a fixed version of STAP.

For the case M=1 and Z<T, the system implements a scalable version of STAP.

For the case M=1 and Z=1, the system implements spatial only processing.

In some embodiments, the design of the STAP/SFAP processor 150 may be scaled to support the largest STAP and SFAP designs (e.g., the largest N and T parameters that may be required for a given application), but not necessarily at the same time, to reduce the computational requirements of the weight solver 240.

In some embodiments, given a maximum limit of W total weights to be solved, the system may be designed with resources to accommodate the maximum number of time taps, but at a reduced effective frequency resolution, which may be implemented as M<N effective bins and Z=T taps.

In some embodiments, given a maximum limit of W total weights to be solved, the system may be designed with resources to accommodate the maximum effective frequency resolution, but at a reduced number of time taps, which may be implemented as M=N effective bins and Z<T taps.

In some embodiments, the weight solver 240 may be designed with resources to accommodate the largest expected value for the combination of M effective bins and Z effective taps. For example, the solver may be designed to solve a maximum of W weights per unit time such that C*M*Z<=W and C*M*Z<C*N*T.

In some embodiments, the weighting filter 260 may be implemented to handle the maximum number of taps T, and for the case where Z<T, all but the center Z taps of the filter may be set to zero (as indicated by the shading of the taps in FIG. 5).

### Methodology

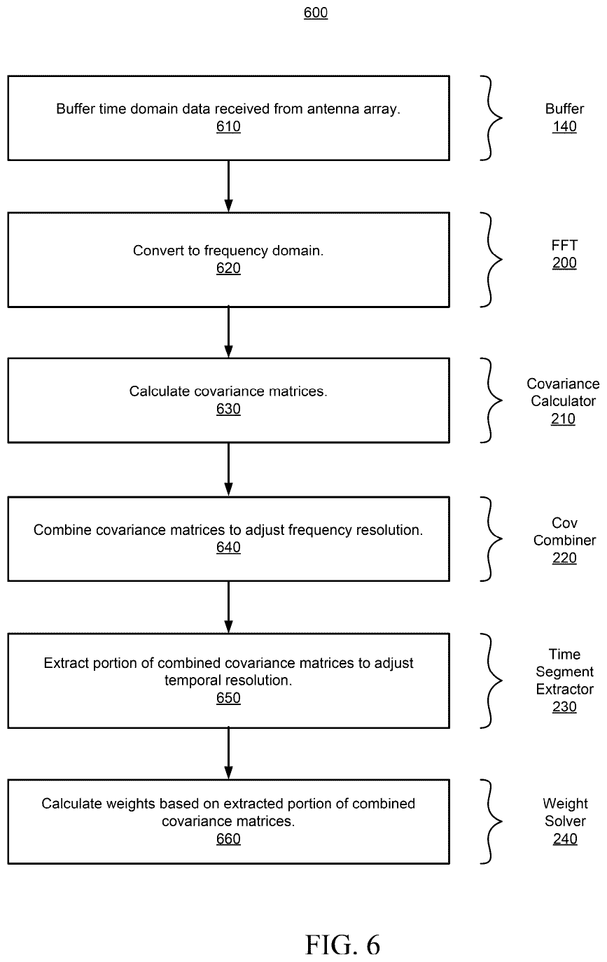

FIG. 6 is a flowchart illustrating a methodology 600 for reconfigurable STAP/SFAP, in accordance with an embodiment of the present disclosure. As can be seen, example method 600 includes a number of phases and sub-processes, the sequence of which may vary from one embodiment to another. However, when considered in aggregate, these phases and sub-processes form a process for operation of the STAP/SFAP processor 150, in accordance with certain of the embodiments disclosed herein, for example as illustrated in FIGS. 1-5, as described above. However other system architectures can be used in other embodiments, as will be apparent in light of this disclosure. To this end, the correlation of the various functions shown in FIG. 6 to the specific components illustrated in the figures, is not intended to imply any structural and/or use limitations. Rather other embodiments may include, for example, varying degrees of integration wherein multiple functionalities are effectively performed by one system. Numerous variations and alternative configurations will be apparent in light of this disclosure.

In one embodiment, method 600 commences, at operation 610, by buffering T blocks of time domain signals received from each of C channels of an antenna array.

At operation 620, the T blocks of time domain signals are converted to T blocks of frequency domain signals for each of the C channels. Each frequency domain signal comprises N frequency domain bins.

At operation 630, N covariance matrices are calculated based on the T blocks of the C frequency domain signals for each of the N frequency domain bins. In some embodiments, each of the covariance matrices are of size CTxCT.

At operation 640, M combined covariance matrices are generated by combining groups of covariance matrices from the N covariance matrices. Each group corresponds to a respective grouping of adjacent frequency domain bins from the N frequency domain bins. In some embodiments, the value of M is selected to be less than N to provide reduced resolution spatial frequency adaptive processing.

At operation 650, M reduced covariance matrices are generated by extracting a portion from each of the M combined covariance matrices, the portion corresponding to Z of the T blocks, wherein Z is less than or equal to T. In some embodiments, the value of Z is selected to be less than T to provide reduced resolution spatial time adaptive processing. In some embodiments, each of the M reduced covariance matrices are of size CZxCZ. In some embodiments, the values of M and Z may be varied over to time to provide dynamic reconfigurability of the system, for example based on a level of interference detected in signals received from the antenna array.

At operation 660, weights are calculated based on the M reduced covariance matrices to control the antenna array. In some embodiments, CxZ weights are calculated for each of the M combined frequency bins. In some embodiments, the weights are calculated using a constraint minimization process to provide one or more of interference mitigation (e.g., anti-jamming), beamforming, or nullforming.

In some embodiments, additional operations may be performed, as previously described in connection with the system. For example, the generated weights are applied to the frequency domain signals for each of the C antennas to generate weighted frequency bins and then the weighted frequency domain bins are converted back to the time domain to generate adaptively processed time domain signals corresponding to each of the C antennas.

### Example System

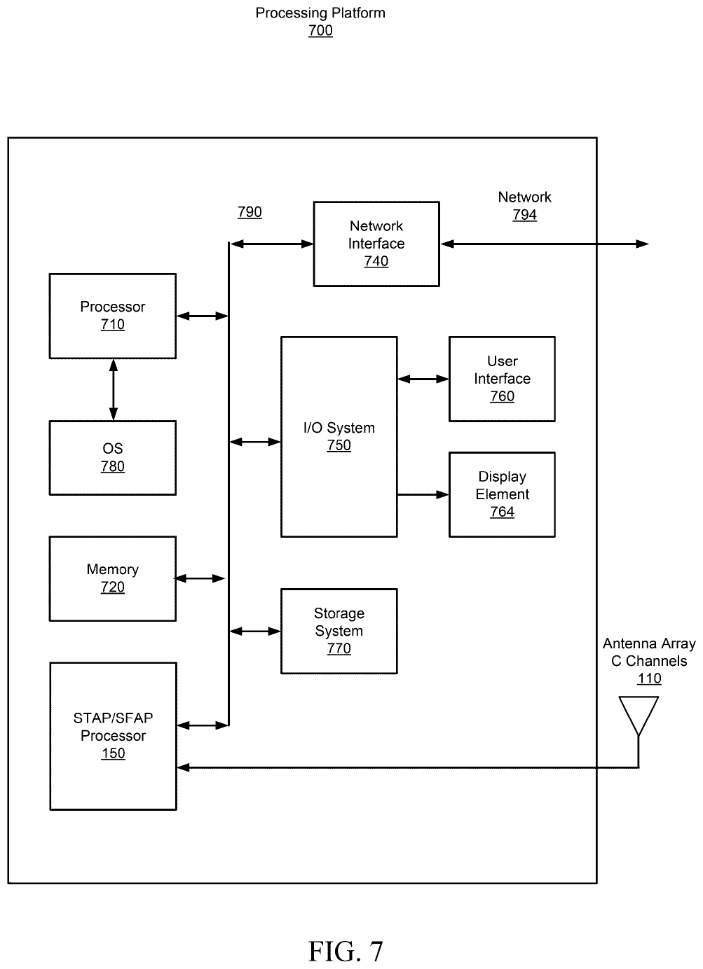

FIG. 7 is a block diagram of a processing platform 700 configured to provide reconfigurable STAP/SFAP, in accordance with an embodiment of the present disclosure. In some embodiments, platform 700, or portions thereof, may be hosted on, or otherwise be incorporated into the receivers or electronic systems of an aircraft, ship, ground station, or man-portable system deployment.

In some embodiments, platform 700 may comprise any combination of a processor 710, memory 720, a network interface 740, an input/output (I/O) system 750, a user interface 760, a display element 764, a storage system 770, STAP/SFAP processor 150, and antenna array 110. As can be further seen, a bus and/or interconnect 790 is also provided to allow for communication between the various components listed above and/or other components not shown. Platform 700 can be coupled to a network 794 through network interface 740 to allow for communications with other computing devices, platforms, devices to be controlled, or other resources. Other componentry and functionality not reflected in the block diagram of FIG. 7 will be apparent in light of this disclosure, and it will be appreciated that other embodiments are not limited to any particular hardware configuration.

Processor 710 can be any suitable processor, and may include one or more coprocessors or controllers, such as an audio processor, a graphics processing unit, or hardware accelerator, to assist in the execution of mission software and/or any control and processing operations associated with platform 700, including operation of the STAP/SFAP processor 150. In some embodiments, the processor 710 may be implemented as any number of processor cores. The processor (or processor cores) may be any type of processor, such as, for example, a micro-processor, an embedded processor, a digital signal processor (DSP), a graphics processor (GPU), a tensor processing unit (TPU), a network processor, a field programmable gate array or other device configured to execute code. The processors may be multithreaded cores in that they may include more than one hardware thread context (or “logical processor”) per core. Processor 710 may be implemented as a complex instruction set computer (CISC) or a reduced instruction set computer (RISC) processor. In some embodiments, processor 710 may be configured as an x86 instruction set compatible processor.

Memory 720 can be implemented using any suitable type of digital storage including, for example, flash memory and/or random access memory (RAM). In some embodiments, the memory 720 may include various layers of memory hierarchy and/or memory caches as are known to those of skill in the art. Memory 720 may be implemented as a volatile memory device such as, but not limited to, a RAM, dynamic RAM (DRAM), or static RAM (SRAM) device. Storage system 770 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device.

Processor 710 may be configured to execute an Operating System (OS) 780 which may comprise any suitable operating system, such as Google Android (Google Inc., Mountain View, CA), Microsoft Windows (Microsoft Corp., Redmond, WA), Apple OS X (Apple Inc., Cupertino, CA), Linux, or a real-time operating system (RTOS). As will be appreciated in light of this disclosure, the techniques provided herein can be implemented without regard to the particular operating system provided in conjunction with platform 700, and therefore may also be implemented using any suitable existing or subsequently-developed platform.

Network interface circuit 740 can be any appropriate network chip or chipset which allows for wired and/or wireless connection between other components of platform 700 and/or network 794, thereby enabling platform 700 to communicate with other local and/or remote computing systems, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution) and 5G, Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 750 may be configured to interface between various I/O devices and other components of platform 700. I/O devices may include, but not be limited to, user interface 760 and display element 764. User interface 760 may include devices (not shown) such as a touchpad, cockpit display unit, keyboard, and mouse, etc., for example, to allow the user to control the system. Display element 764 may be configured to display information to a user. I/O system 750 may include a graphics subsystem configured to perform processing of images for rendering on the display element 764. Graphics subsystem may be a graphics processing unit or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into processor 710 or any chipset of platform 700.

It will be appreciated that in some embodiments, the various components of platform 700 may be combined or integrated in a system-on-a-chip (SoC) architecture. In some embodiments, the components may be hardware components, firmware components, software components or any suitable combination of hardware, firmware, or software.

STAP/SFAP processor 150 is configured to provide dynamically reconfigurable space time and space frequency adaptive processing to generate weights for an antenna array, as described previously. STAP/SFAP processor 150 may include any or all of the circuits/components illustrated in FIGS. 1 and 2, as described above. These components can be implemented or otherwise used in conjunction with a variety of suitable software and/or hardware that is coupled to or that otherwise forms a part of platform 700. These components can additionally or alternatively be implemented or otherwise used in conjunction with user I/O devices that are capable of providing information to, and receiving information and commands from, a user.

In various embodiments, platform 700 may be implemented as a wireless system, a wired system, or a combination of both. When implemented as a wireless system, platform 700 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, platform 700 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the methodologies disclosed herein to be implemented. The instructions can be encoded using a suitable programming language, such as C, C++, object oriented C, Java, JavaScript, Visual Basic .NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one embodiment, the system can be hosted on a given website and implemented, for example, using JavaScript or another suitable browser-based technology. For instance, in certain embodiments, the system may leverage processing resources provided by a remote computer system accessible via network 794.

The computer software applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other embodiments are not limited to any particular hardware or software configuration. Thus, in other embodiments platform 700 may comprise additional, fewer, or alternative subcomponents as compared to those included in the example embodiment of FIG. 7.

The aforementioned non-transitory computer readable medium may be any suitable medium for storing digital information, such as a hard drive, a server, a flash memory, and/or random-access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method, process, and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood, however, that other embodiments may be practiced without these specific details, or otherwise with a different set of details. It will be further appreciated that the specific structural and functional details disclosed herein are representative of example embodiments and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

Example 1 is an adaptive signal processing system, the system comprising: a fast Fourier transform (FFT) circuit configured to convert T blocks of time domain signals to T blocks of frequency domain signals for each of C channels, the T blocks of time domain signals derived from each of the C channels of an antenna array, each frequency domain signal comprising N frequency domain bins; a covariance calculator circuit configured to calculate N covariance matrices based on the T blocks of the C frequency domain signals for each of the N frequency domain bins, each of the covariance matrices of size C times T by C times T; a covariance combiner circuit configured to generate M combined covariance matrices by combining groups of covariance matrices from the N covariance matrices, each group corresponding to a respective grouping of adjacent frequency domain bins from the N frequency domain bins; a time segment extractor configured to generate M reduced covariance matrices by extracting a portion from each of the M combined covariance matrices, the portion corresponding to Z of the T blocks, wherein Z is less than or equal to T; and a weight solver circuit configured to calculate weights based on the M reduced covariance matrices to control the antenna array.

Example 2 includes the system of Example 1, wherein the weights are calculated using a constraint minimization process to provide one or more of interference mitigation, beamforming, or nullforming.

Example 3 includes the system of any of Examples 1 or 2, comprising: a memory buffer configured to buffer the T blocks of time domain signals received from each of C channels of the antenna array; a finite impulse response (FIR) filter configured to apply the weights to the frequency domain signals to generate weighted frequency bins; and/or an inverse fast Fourier transform (IFFT) circuit configured to convert the weighted frequency domain bins to the time domain to generate adaptively processed time domain signals.

Example 4 includes the system of any of Examples 1-3, wherein a first value of M and a first value of Z are selected at a first time instance, and a second value of M and a second value of Z are selected at a second time instance.

Example 5 includes the system of any of Examples 1-4, wherein a value of M is selected to be less than N to provide reduced resolution spatial frequency adaptive processing.

Example 6 includes the system of any of Examples 1-5, wherein a value of Z is selected to be less than T to provide reduced resolution spatial time adaptive processing.

Example 7 includes the system of any of Examples 1-6, wherein a value of M and a value of Z are selected based on a level of interference detected in signals received from the antenna array.

Example 8 is a computer program product including one or more non-transitory machine-readable mediums encoded with instructions that when executed by one or more processors cause a process to be carried out for adaptive signal processing, the process comprising: buffering T blocks of time domain signals received from each of C channels of an antenna array; converting the T blocks of time domain signals to T blocks of frequency domain signals for each of the C channels, each frequency domain signal comprising N frequency domain bins; calculating N covariance matrices based on the T blocks of the C frequency domain signals for each of the N frequency domain bins, each of the covariance matrices of size C times T by C times T; generating M combined covariance matrices by combining groups of covariance matrices from the N covariance matrices, each group corresponding to a respective grouping of adjacent frequency domain bins from the N frequency domain bins; generating M reduced covariance matrices by extracting a portion from each of the M combined covariance matrices, the portion corresponding to Z of the T blocks, wherein Z is less than or equal to T; and calculating weights based on the M reduced covariance matrices to control the antenna array.

Example 9 includes the computer program product of Example 8, wherein the weights are calculated using a constraint minimization process to provide one or more of interference mitigation, beamforming, or nullforming.

Example 10 includes the computer program product of Examples 8 or 9, wherein the process further comprises: applying the weights to the frequency domain signals to generate weighted frequency bins; and converting the weighted frequency domain bins to the time domain to generate adaptively processed time domain signals.

Example 11 includes the computer program product of any of Examples 8-10, wherein a first value of M and a first value of Z are selected at a first time instance, and a second value of M and a second value of Z are selected at a second time instance.

Example 12 includes the computer program product of any of Examples 8-11, wherein a value of M is selected to be less than N to provide reduced resolution spatial frequency adaptive processing.

Example 13 includes the computer program product of any of Examples 8-12, wherein a value of Z is selected to be less than T to provide reduced resolution spatial time adaptive processing.

Example 14 includes the computer program product of any of Examples 8-13, wherein a value of M and a value of Z are selected based on a level of interference detected in signals received from the antenna array.

Example 15 is a method for adaptive signal processing, the method comprising: converting T blocks of buffered time domain signals to T blocks of frequency domain signals for each of C channels, the T blocks of buffered time domain signals received from each of the C channels of an antenna array, each frequency domain signal comprising N frequency domain bins; calculating N covariance matrices based on the T blocks of the C frequency domain signals for each of the N frequency domain bins, each of the covariance matrices of size C times T by C times T; generating M combined covariance matrices by combining groups of covariance matrices from the N covariance matrices, each group corresponding to a respective grouping of adjacent frequency domain bins from the N frequency domain bins; generating M reduced covariance matrices by extracting a portion from each of the M combined covariance matrices, the portion corresponding to Z of the T blocks, wherein Z is less than or equal to T; and calculating weights based on the M reduced covariance matrices to control the antenna array.

Example 16 includes the method of Example 15, wherein the weights are calculated using a constraint minimization process to provide one or more of interference mitigation, beamforming, or nullforming.

Example 17 includes the method of Examples 15 or 16, comprising: buffering T blocks of time domain signals to provide the T blocks of buffered time domain signals received from each of C channels of the antenna array; applying the weights to the frequency domain signals to generate weighted frequency bins; and/or converting the weighted frequency domain bins to the time domain to generate adaptively processed time domain signals.

Example 18 includes the method of any of Examples 15-17, wherein a first value of M and a first value of Z are selected at a first time instance, and a second value of M and a second value of Z are selected at a second time instance.

Example 19 includes the method of any of Examples 15-18, wherein a value of M is selected to be less than N to provide reduced resolution spatial frequency adaptive processing.

Example 20 includes the method of any of Examples 15-19, wherein a value of Z is selected to be less than T to provide reduced resolution spatial time adaptive processing.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. An adaptive signal processing system, the system comprising:
a fast Fourier transform (FFT) circuit configured to convert T blocks of time domain signals to T blocks of frequency domain signals for each of C channels, the T blocks of time domain signals derived from each of the C channels of an antenna array, each frequency domain signal comprising N frequency domain bins;
a covariance calculator circuit configured to calculate N covariance matrices based on the T blocks of the C frequency domain signals for each of the N frequency domain bins, each of the covariance matrices of size C times T by C times T;
a covariance combiner circuit configured to generate M combined covariance matrices by combining groups of covariance matrices from the N covariance matrices, each group corresponding to a respective grouping of adjacent frequency domain bins from the N frequency domain bins;
a time segment extractor configured to generate M reduced covariance matrices by extracting a portion from each of the M combined covariance matrices, the portion corresponding to Z of the T blocks, wherein Z is less than or equal to T; and
a weight solver circuit configured to calculate weights based on the M reduced covariance matrices to control the antenna array.

2. The system of claim 1, wherein the weights are calculated using a constraint minimization process to provide one or more of interference mitigation, beamforming, or nullforming.

3. The system of claim 1, comprising:
a memory buffer configured to buffer the T blocks of time domain signals received from each of C channels of the antenna array;
a finite impulse response (FIR) filter configured to apply the weights to the frequency domain signals to generate weighted frequency bins; and/or
an inverse fast Fourier transform (IFFT) circuit configured to convert the weighted frequency domain bins to the time domain to generate adaptively processed time domain signals.

4. The system of claim 1, wherein a first value of M and a first value of Z are selected at a first time instance, and a second value of M and a second value of Z are selected at a second time instance.

5. The system of claim 1, wherein a value of M is selected to be less than N to provide reduced resolution spatial frequency adaptive processing.

6. The system of claim 1, wherein a value of Z is selected to be less than T to provide reduced resolution spatial time adaptive processing.

7. The system of claim 1, wherein a value of M and a value of Z are selected based on a level of interference detected in signals received from the antenna array.

8. A computer program product including one or more non-transitory machine-readable mediums encoded with instructions that when executed by one or more processors cause a process to be carried out for adaptive signal processing, the process comprising:
buffering T blocks of time domain signals received from each of C channels of an antenna array;
converting the T blocks of time domain signals to T blocks of frequency domain signals for each of the C channels, each frequency domain signal comprising N frequency domain bins;
calculating N covariance matrices based on the T blocks of the C frequency domain signals for each of the N frequency domain bins, each of the covariance matrices of size C times T by C times T;
generating M combined covariance matrices by combining groups of covariance matrices from the N covariance matrices, each group corresponding to a respective grouping of adjacent frequency domain bins from the N frequency domain bins;
generating M reduced covariance matrices by extracting a portion from each of the M combined covariance matrices, the portion corresponding to Z of the T blocks, wherein Z is less than or equal to T; and
calculating weights based on the M reduced covariance matrices to control the antenna array.

9. The computer program product of claim 8, wherein the weights are calculated using a constraint minimization process to provide one or more of interference mitigation, beamforming, or nullforming.

10. The computer program product of claim 8, wherein the process further comprises:
applying the weights to the frequency domain signals to generate weighted frequency bins; and
converting the weighted frequency domain bins to the time domain to generate adaptively processed time domain signals.

11. The computer program product of claim 8, wherein a first value of M and a first value of Z are selected at a first time instance, and a second value of M and a second value of Z are selected at a second time instance.

12. The computer program product of claim 8, wherein a value of M is selected to be less than N to provide reduced resolution spatial frequency adaptive processing.

13. The computer program product of claim 8, wherein a value of Z is selected to be less than T to provide reduced resolution spatial time adaptive processing.

14. The computer program product of claim 8, wherein a value of M and a value of Z are selected based on a level of interference detected in signals received from the antenna array.

15. A method for adaptive signal processing, the method comprising:
converting T blocks of buffered time domain signals to T blocks of frequency domain signals for each of C channels, the T blocks of buffered time domain signals received from each of the C channels of an antenna array, each frequency domain signal comprising N frequency domain bins;
calculating N covariance matrices based on the T blocks of the C frequency domain signals for each of the N frequency domain bins, each of the covariance matrices of size C times T by C times T;
generating M combined covariance matrices by combining groups of covariance matrices from the N covariance matrices, each group corresponding to a respective grouping of adjacent frequency domain bins from the N frequency domain bins;
generating M reduced covariance matrices by extracting a portion from each of the M combined covariance matrices, the portion corresponding to Z of the T blocks, wherein Z is less than or equal to T; and
calculating weights based on the M reduced covariance matrices to control the antenna array.

16. The method of claim 15, wherein the weights are calculated using a constraint minimization process to provide one or more of interference mitigation, beamforming, or nullforming.

17. The method of claim 15, comprising:
buffering T blocks of time domain signals to provide the T blocks of buffered time domain signals received from each of C channels of the antenna array;
applying the weights to the frequency domain signals to generate weighted frequency bins; and/or
converting the weighted frequency domain bins to the time domain to generate adaptively processed time domain signals.

18. The method of claim 15, wherein a first value of M and a first value of Z are selected at a first time instance, and a second value of M and a second value of Z are selected at a second time instance.

19. The method of claim 15, wherein a value of M is selected to be less than N to provide reduced resolution spatial frequency adaptive processing.

20. The method of claim 15, wherein a value of Z is selected to be less than T to provide reduced resolution spatial time adaptive processing.
